(19) United States
(12) Patent Application Publication
(10) Pub. No.: US 2006/0159136 A1
(43) Pub. Date: Jul. 20, 2006

(54) Beam combiner

(76) Inventor: Stefan Spiekermann, Jarfalla (SE)

Correspondence Address: BUCHANAN INGERSOLL LLP;(INCLUDING BURNS, DOANE, SWECKER & MATHIS), P.O. BOX 1404, ALEXANDRIA, VA, 22313-1404, US

(21) Appl. No.: 10/561,815

(22) PCT Filed: Jun. 23, 2004
(86) PCT No.: PCT/SE04/01026

§ 371 Date: Mar. 10, 2006

(30) Foreign Application Priority Data
Jun. 24, 2003 (SE) 03018125

(51) Int. Cl. H01S 3/10; H01S 3/08

(52) U.S. Cl. 372/21; 372/106

(57) ABSTRACT

A laser arrangement with a resonant cavity which is folded by a folding mirror is disclosed. A quarter wave plate and a retro-reflector are arranged outside one of the cavity mirrors. Frequency converted light that exits the cavity through this cavity mirror passes the wave plate twice before re-entering the cavity. In this way, light re-enters the cavity with a polarization direction that is orthogonal to its original polarization direction, and a combined, non-polarized output beam is obtained from the laser arrangement.

### TECHNICAL FIELD

The present invention relates to a laser arrangement comprising a resonant optical cavity, preferably of folded geometry, in which frequency conversion is performed.

### BACKGROUND OF THE INVENTION

Lasers having a resonant cavity of folded geometry are known in the art. In a folded laser cavity, at least two branches are present, which are separated by a folding mirror. In one of the branches, an active laser material can be arranged, whilst a non-linear element for frequency conversion is arranged in the other branch.

When frequency conversion is carried out within the resonant laser cavity (“intra-cavity frequency conversion”), it is often desired to extract the frequency converted light from the cavity before it passes the non-linear element a second time. The reason for this is that back-conversion should be avoided in order to keep the overall conversion efficiency high. In a folded cavity geometry, this means that frequency converted light is outputted as quickly as possible and hence in two directions. However, for most practical applications, the output should be combined into a single beam.

Consequently, there is a general problem in the prior art of how to combine the two beams emitted from a folded cavity laser of the above-mentioned kind.

### SUMMARY OF THE INVENTION

Hence, it is an object of the present invention to provide a laser arrangement of the type having a folded cavity, in which frequency conversion is carried out in one branch of the cavity, for which the emitted beams are combined into a single output beam.

A further object of the invention is to obtain a frequency converted beam that does not interfere with the fundamental beam, and thus is stable and displays excellent beam qualities.

This object is met by a laser arrangement according to claim 1.

Hence, a laser arrangement according to the invention preferably comprises a folded cavity defined by a first cavity mirror, a second cavity mirror and a folding mirror. The cavity is divided into a first and a second branch by the folding mirror. Frequency conversion is carried out by means of a non-linear element in the second branch of the cavity. The folding mirror and the second cavity mirror, which define the second branch of the folded cavity, are both highly transmitting for the frequency converted light.

The laser arrangement according to the invention is characterized by having a quarter wave plate and a retro-reflector for the frequency converted light arranged in the beam path outside the cavity adjacent to the second cavity mirror.

Owing to this, frequency converted light that exits the cavity through the second cavity mirror passes the wave plate, reflects off the retro-reflector, passes the wave plate a second time, and then re-enters the second branch of the cavity. Due to the two passes through the wave plate, the frequency converted beam undergoes a polarization rotation of 90 degrees (provided that the optic axis of the wave plate is properly aligned with respect to the original polarization).

Preferably, the laser material is Nd:YAG and the cavity is designed for fundamental oscillation at 1064 nm or at 946 nm, in order to produce a frequency-doubled output at 532 nm or 473 nm, respectively. Other suitable laser materials are Nd:YVO₄ and Nd:GdVO₄ both operating at a fundamental frequency of about 1064 nm and 914 nm. However, the invention is not limited to any particular choice of laser material since the teachings of this description can be applied to any solid state laser material.

Furthermore, the laser material can be operative to emit two different fundamental frequencies, and the non-linear element can be designed for sum-frequency mixing of these fundamental frequencies. It is also possible to have two or more laser materials within the cavity in order to produce the two fundamental frequencies.

The laser arrangement according to the present invention provides a way of combining two frequency converted beams into a single beam. When light of the fundamental frequencies pass through the non-linear element, conversion into a frequency converted beam takes place. Since the non-linear element is placed within the resonant cavity, this conversion takes place in two opposite directions, because the fundamental light passes through the non-linear element in two directions. Typically, the frequency converted beam has a linear polarization.

In the propagation path of the frequency converted beam, a quarter wave-plate (λ/4-plate) and a back-reflecting mirror are provided. When the (linearly polarized) frequency converted light passes the quarter wave-plate in one direction, its polarization is changed to circular. Then, the light is reflected from the back-reflecting mirror and passes the quarter wave-plate once more, whereby the now circular polarization is changed to linear again, but orthogonal to the original polarization state. Since two orthogonally polarized beams cannot interfere, the frequency converted beam can pass through the cavity without interfering with any other light. This is advantageous in that a combined, cross-polarized output can be obtained in a simple fashion without introducing interference effects in the cavity, thereby generating more stable intensity in the output.

### DETAILED DESCRIPTION OF PREFERRED EMBODIMENTS

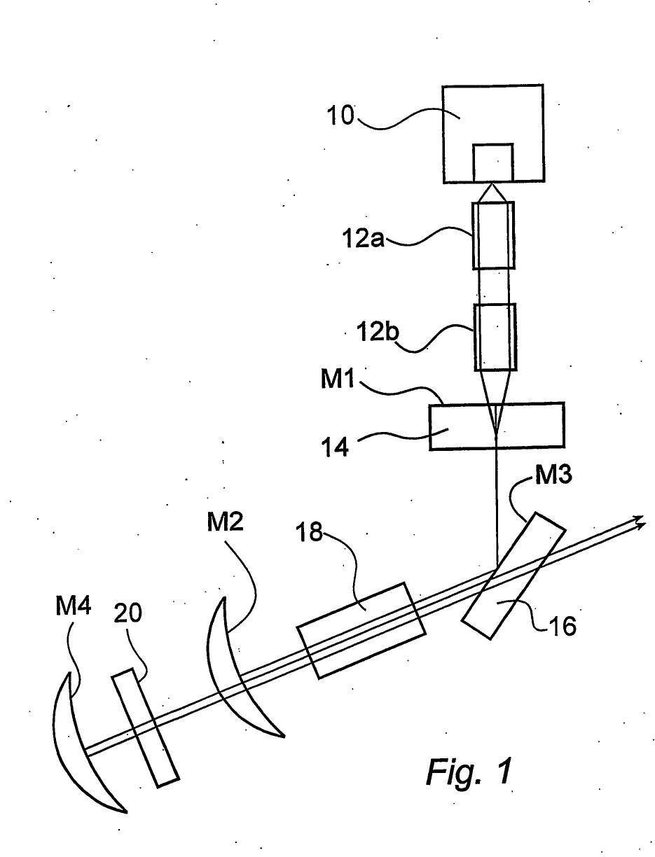

A detailed description of a preferred embodiment of the invention is presented below. In the description, reference is made to the accompanying drawing (FIG. 1), which schematically shows a laser arrangement according to the invention.

When using non linear elements for frequency conversion inside a cavity, the light of the fundamental frequency entering the non linear element is preferably linearly polarized. This can of course either be achieved by using a laser material that emits only linearly polarized light or by inserting a polarizing element in the beam path, such as a linear polarizer or a Brewster plate.

Reference is now made to the figure, where an embodiment of the present invention is shown.

This embodiment of the invention comprises a resonant cavity defined by a first cavity mirror M1, a second cavity mirror M2 and a third cavity mirror M3, of which the third mirror M3 is a folding mirror. The term folding mirror is used here in the sense that such mirror “folds” the resonant cavity such that two branches are defined with the folding mirror at the intersection between the branches. The laser arrangement further comprises a solid state laser material 14 and a pump source 10 for providing pump light to the laser material 14. When pumped with pump light, the laser material 14 emits one or more fundamental frequencies of light. The laser material 14 is located in the first branch of the cavity. In the second branch of the cavity, there is provided a non-linear element 18, which is adapted to convert one or more fundamental frequencies into a frequency converted beam.

The folding mirror M3 is suitably comprised of a multilayer stack on a substrate made of glass or the like, and is coated for high reflection of the or each fundamental frequencies and high transmission of the frequency converted beam Preferably, the non-linear element comprises a quasi-phasematching (QPM) grating. The element can be, for example, periodically poled potassium-titanyl-phosphate (PP-KTP). However, a wide range of other non-linear elements can also be used.

For practical reasons, the light emitted from the pump source is collected and shaped by means of beam shaping optics such as an arrangement of gradient index lenses (GRIN-lenses) 12.

According to the present invention the laser arrangement further comprises a quarter-wave plate 20 and a back-reflecting mirror M4 outside the second cavity mirror M2. Hence, linearly polarized frequency converted light that exits the cavity through the second cavity mirror M2 passes the quarter-wave plate 20, is reflected from the retro-reflecting mirror M4, and once more passes the quarter-wave plate before it re-enters the cavity through the second mirror M2. Consequently, the linearly polarized frequency converted light is transformed into circularly polarized light after the first passage of the quarter-wave plate. After the second passage of the quarter-wave plate, the light is further transformed into a linear polarization state, but now orthogonal to the original polarization state. This means that frequency converted light generated in the non-linear element 18 during propagation of the fundamental frequency towards the second mirror M2 has its polarization state rotated 90 degrees before it re-enters the cavity. However, frequency converted light generated in the non-linear element 18 during propagation of the fundamental frequency towards the folding mirror M3 remains in its original polarization state. These two components of frequency converted light inside the cavity thus have orthogonal polarization states, and will not interfere with each other. The result is that a single beam of converted light is emitted through the folding mirror M3 in a “crossed” polarization state (overlapped beams). This is schematically shown in the figure by two overlapped (slightly displaced) arrows. A condition for achieving an overlap of the two beams is that the radius of curvature and the position of the retro-reflective mirror is correctly chosen. Not only does this arrangement give the advantage that more light is obtained in a single beam. It also has the advantage that interference effects in the frequency converted beam are completely eliminated.

### EXAMPLE

A practical example of an embodiment of the invention is outlined below.
The laser material is a 3 mm long Nd:YAG crystal (an isotropic material), in which the Nd-content is 0.6 at %.
The pump source is a 200 μm wide stripe diode laser with an output of 2 W at 808 nm.
The non-linear element is a 2 mm long, periodically poled potassium-titanyl-phosphate (PP-KTP) having a grating period adapted for second harmonic generation of light at 946 nm at room temperature.
Beam shaping optics is provided for coupling the light from the pump source into the laser material.
The first cavity mirror is deposited on the laser material, on the side facing the pump source. This first mirror is flat and has a high reflectivity for 946 nm.
The second cavity mirror is an curved end mirror, which radius is about 50 mm. The mirror has a high transmission for the 473 nm and a high reflectance for 946 nm.
The third mirror is the folding mirror, which is a flat multi layered mirror on a glass substrate coated for high transmission of 473 nm light and for high reflectivity of 946 nm p-polarised light and for lower reflectivity of 946 nm s-polarised light. The mirror is oriented in such a way that the light generated in the active laser material is incident on the mirror with an angle of 56 degrees.
The fourth mirror is a curved mirror with a high reflectance for 473 nm.
The λ/4-plate rotates the polarization of the 473 nm light.

### CONCLUSION

In a laser arrangement from which two frequency converted beams are emitted in opposite directions, beam combination of these beams into a single beam is obtained by rotating one of the outputs to an orthogonal polarization state and then superposing the two beams in a common propagation direction. The rotation of the polarization state is obtained by means of a quarter wave plate and a back-reflecting mirror. Hence, a single output beam is obtained in a “crossed” polarization configuration. Therefore, detrimental polarization effects in the overlapped beams are eliminated, canceling the interference and intensity fluctuations in the output beam.

Furthermore, although the invention has been described with reference to a laser of folded geometry, it is to be understood that the invention can be applied for any laser geometry.

1. A laser arrangement, comprising
a resonant cavity that is resonant to one or more fundamental frequencies;
a solid state laser material provided in the resonant cavity for emitting at least one of said one or more fundamental frequencies when being irradiated by pump light;
pumping means for providing pump light to said laser material;
a non-linear optical element provided in the resonant cavity, said non-linear optical element being adapted to convert one or more of said fundamental frequencies into a frequency converted beam;
wherein at least one cavity mirror defining the resonant cavity is highly transmitting for said frequency converted beam;
wherein a quarter wave-plate and a retro-reflector for the frequency converted beam are arranged in series in the beam path outside the cavity adjacent to said cavity mirror, such that the frequency converted beam leaving the cavity through said mirror undergoes a polarization rotation and re-enters the cavity in a polarization state orthogonal to its original polarization state.

2. A laser arrangement as claimed in claim 1, wherein the cavity is defined by a first cavity mirror, a second cavity mirror and a folding mirror, said folding mirror defining a first cavity branch between said folding mirror and the first cavity mirror and defining a second cavity branch between said folding mirror and the second cavity mirror, the non-linear element being provided in the second branch, and wherein the second mirror and the folding mirror are both highly transmitting for the frequency converted beam.

3. A laser arrangement as claimed in claim 1, wherein the retro-reflector (M4) has a radius of curvature and a position with respect to the resonant cavity in order for two cross-polarized output beams to overlap spatially and exit said cavity as a single beam.

4. A laser arrangement according to claim 1, wherein the non-linear element comprises a quasi phase-matching grating.

5. A laser arrangement according to claim 4, wherein the non-linear element comprises a periodically poled potassium-titanyl-phosphate (PP-KTP) crystal.

6. A laser arrangement according to claim 1, wherein the laser material comprises a neodymium-doped crystal selected from YAG, YVO₄ and GdVO₄.

7. A laser arrangement as claimed in claim 2, wherein the retro-reflector (M4) has a radius of curvature and a position with respect to the resonant cavity in order for two cross-polarized output beams to overlap spatially and exit said cavity as a single beam.

8. A laser arrangement according to claim 2, wherein the non-linear element comprises a quasi phase-matching grating.

9. A laser arrangement according to claim 3, wherein the non-linear element comprises a quasi phase-matching grating.

10. A laser arrangement according to claim 7, wherein the non-linear element comprises a quasi phase-matching grating.

11. A laser arrangement according to claim 2, wherein the laser material comprises a neodymium-doped crystal selected from YAG, YVO₄ and GdVO₄.

12. A laser arrangement according to claim 3, wherein the laser material comprises a neodymium-doped crystal selected from YAG, YVO₄ and GdVO₄.

13. A laser arrangement according to claim 4, wherein the laser material comprises a neodymium-doped crystal selected from YAG, YVO₄ and GdVO₄.

14. A laser arrangement according to claim 5, wherein the laser material comprises a neodymium-doped crystal selected from YAG, YVO₄ and GdVO₄.

15. A laser arrangement according to claim 7, wherein the laser material comprises a neodymium-doped crystal selected from YAG, YVO₄ and GdVO₄.

16. A laser arrangement according to claim 10, wherein the laser material comprises a neodymium-doped crystal selected from YAG, YVO₄ and GdVO₄.
